(19) United States
(12) Patent Application Publication
(10) Pub. No.: US 2014/0234386 A1
(43) Pub. Date: Aug. 21, 2014

(54) MINERAL FEED-THROUGH FORMULATION

(71) Applicant: WELLMARK INTERNATIONAL, SCHAUMBURG, IL (US)

(72) Inventors: C. Jason Hunter, RICHARDSON, TX (US); JEANNE PARKER, WAXAHACHIE, TX (US)

(21) Appl. No.: 14/179,506

(22) Filed: Feb. 12, 2014

Related U.S. Application Data
(60) Provisional application No. 61/765,622, filed on Feb. 15, 2013.

(51) Int. Cl. A01N 25/00; A01N 37/06

(52) U.S. Cl. CPC A01N 25/002; A01N 37/06
USPC 424/410; 514/552; 514/616; 514/345

(57) ABSTRACT

The present invention provides feed-through pesticide formulation suitable for hydrophobic active ingredients. The formulation comprises a hydrophobic active ingredient on a solid carrier, with a hydrophilic coating and an optional hydrophobic coating contacting the hydrophilic coating.

### CROSS-REFERENCE TO RELATED APPLICATIONS

This application claims priority to U.S. Provisional Patent Application No. 61/765,622, filed Feb. 15, 2013, the disclosure of which is hereby incorporated by reference in its entirety for all purposes.

### BACKGROUND OF THE INVENTION

Scientists estimate that horn flies (Haematobia irritans) cost U.S. cattle producers $876 million each year. Together with fire ants and nuisance flies, they have a tremendously negative impact on the profits of farmers and ranchers in every industry.

Infestation occurs rapidly with 1000-4000 flies per animal in an untreated herd. In general, horn flies congregate on the back and shoulders of cattle, and tend to rest quietly on the host. Horn flies rarely leave their host, except to lay eggs, change host animals or remain outdoors when the host moves indoors. Because they are a nuisance to the cattle, horn flies interrupt grazing patterns. The cattle tend to waste energy and even go off their feed. Due to horn flies infestations, calves are lighter at weaning by about 10-25 pounds. In addition, a 14% weight loss over 120 day fly period can amount to 26 lbs. per head. In the summer season, horn flies can cause 15-50 lbs. loss per head. At $0.90 per lb., a 30 lb. weight loss equals a $27.00 loss per head. Moreover, cows can go out of condition during breeding.

In certain instances, mineral feeds are needed in order to augment the diet of cattle. Minerals can also act as carriers for active ingredients that pass through the animal and control immature horn flies in the fresh manure where they develop. Minerals can render the active ingredient inactive by catalyzing degradation, oxidation or hydrolysis. Minerals thus can be detrimental to feed-through formulations. In view of the foregoing, there is a need for new more effective pesticide formulations suitable for mineral feed. The present invention satisfies these and other needs.

### BRIEF SUMMARY OF THE INVENTION

In one embodiment, the present invention provides a pesticide formulation, preferably a feed-through formulation, comprising, consisting essentially of, or consisting of:
a) a hydrophobic active ingredient on a solid carrier;
b) a hydrophilic coating contacting the solid carrier;
c) an antioxidant; and
d) optionally an external hydrophobic coating contacting the hydrophilic coating. In certain instances the active ingredient is an insect growth regulator (IGR), such as methoprene, diflubenzuron, pyriproxyfen, or a combination thereof. The solid carrier can be corn cobb grit, dried molasses, soybean hulls, verxite, or a mixture thereof. Advantageously, hydrophobic/hydrophilic system is exceptionally stable with a long-shelf-life.

In another embodiment, the present invention provides a method for controlling an insect on cattle, the method comprising, consisting essentially of, or consisting of: oral administration of a pesticide formulation to cattle, the formulation comprising:
a) a hydrophobic active ingredient on a solid carrier;
b) a hydrophilic coating contacting the solid carrier;
c) an antioxidant; and
d) optionally an external hydrophobic coating contacting the hydrophilic coating; and allowing the formulation to pass through the cattle into manure, wherein the pesticide is released into the manure thereby controlling the insect.

In yet another embodiment, the present invention provide a use of a pesticide formulation for controlling an insect on cattle, the formulation comprising:
a) a hydrophobic active ingredient on a solid carrier;
b) a hydrophilic coating contacting the solid carrier;
c) an antioxidant; and
d) an optional external hydrophobic coating contacting the hydrophilic coating.

These and other aspects, objects, and embodiments, will become more apparent when read with the following detailed description and figures which follow.

### BRIEF DESCRIPTION OF THE DRAWINGS

FIG. 1 illustrates the solid carrier architecture of one granular formulation of the present invention.

FIG. 2 shows the results of an accelerated stability screen at 40° C. storage.

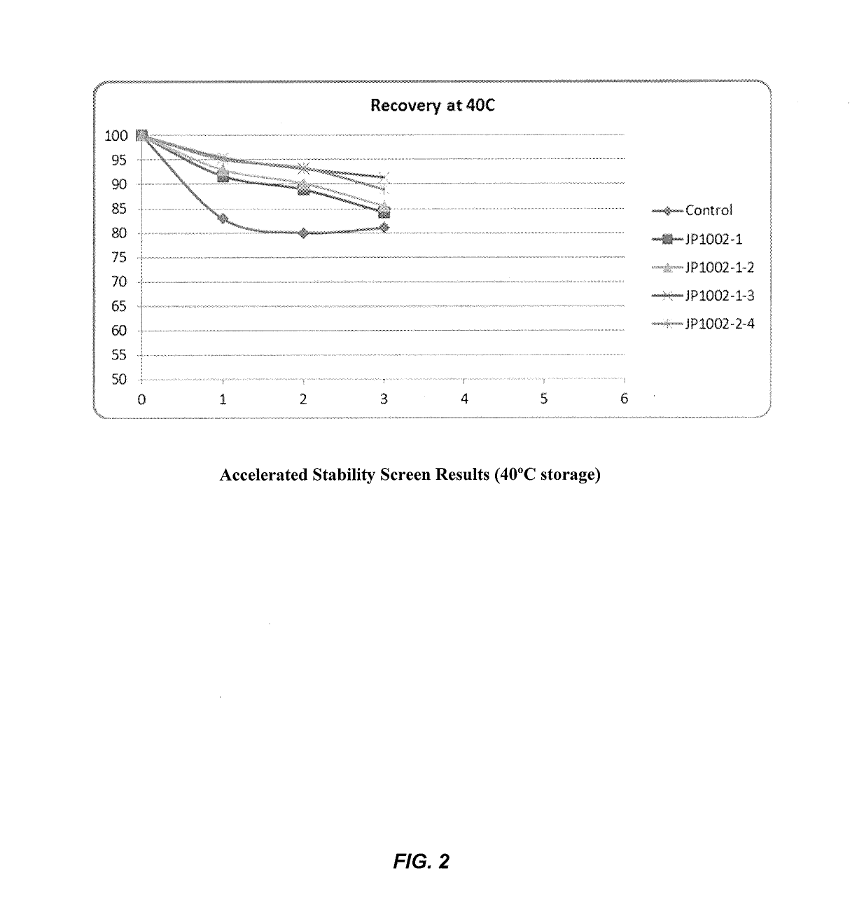

FIG. 3 shows the results of an ambient stability screen.

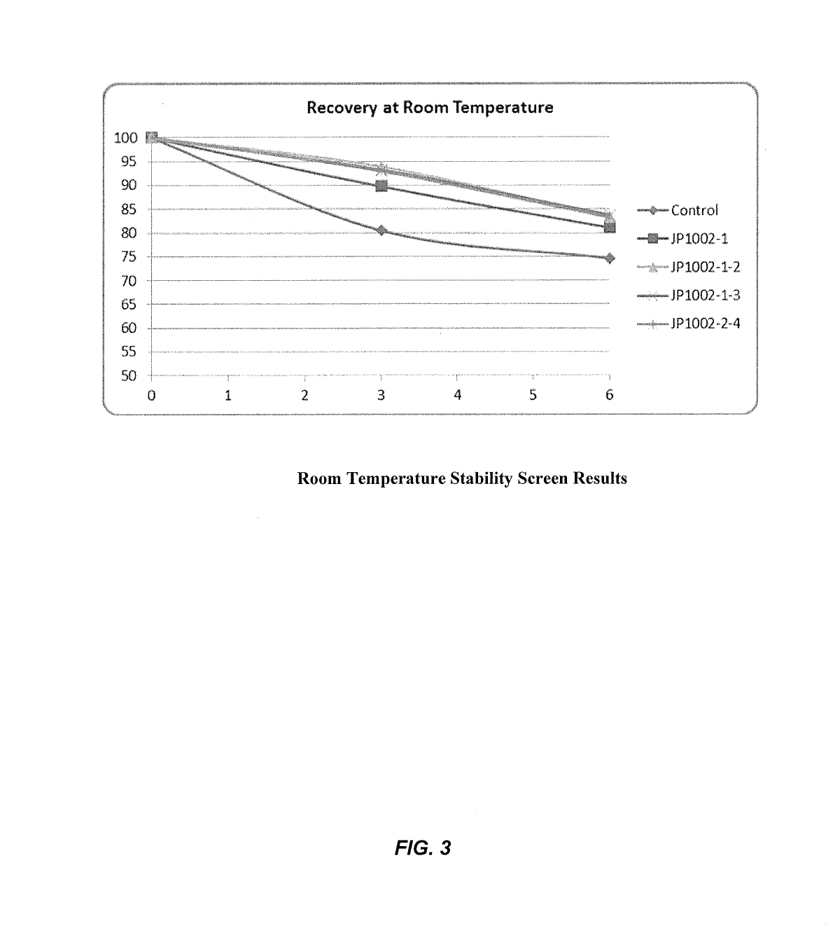

FIG. 4 shows the results of an ambient recovery screen test in commercial mineral feed over 6 months.

### DETAILED DESCRIPTION

### I. Embodiments

The present invention provides pesticide formulations, and methods of making and using them. In particular, the present invention provides a pesticide formulation, comprising:
a) a hydrophobic active ingredient coated onto a solid carrier;
b) a hydrophilic coating contacting the solid carrier;
c) an antioxidant; and
d) an optional external hydrophobic coating contacting the hydrophilic coating.

Advantageously, in certain aspects, the pesticide formulations of the present invention can be used in feed-through products to treat and control insect infestation in cattle. Various insects can be controlled and treated using the formulations and methods of the present invention. These include, but are not limited to, face flies, house flies, stable flies and horn flies. Horn flies are especially susceptible to the formulations and methods of the present invention.

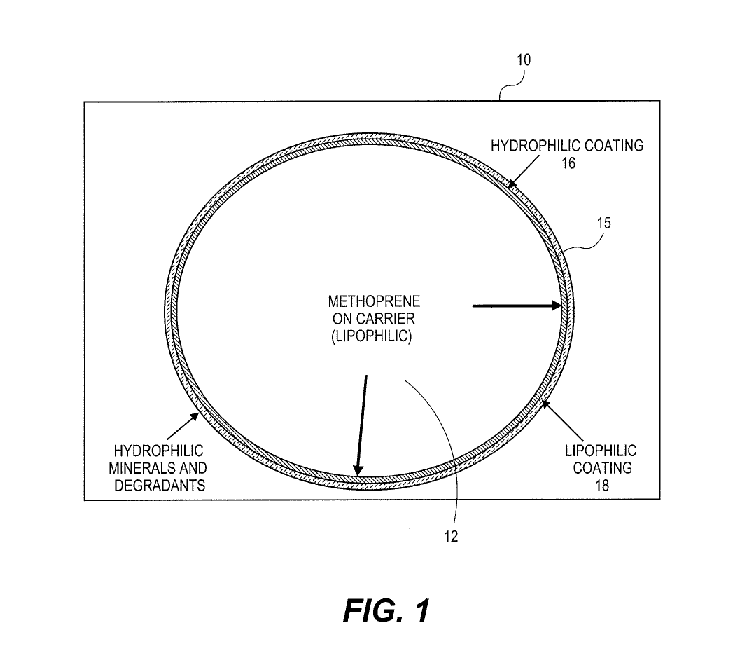

In certain aspects, the formulation of the present invention has an architecture as is shown in FIG. 1. As is shown therein, the formulation 10 has a solid carrier 12. A hydrophobic active ingredient 15 such as methoprene is absorbed or adsorbed onto the carrier. Thereafter, a hydrophilic coating 16 such polyethylene glycol is layered or coated on after the hydrophobic active ingredient. A lipophilic coating 18 surrounds or is layered or coated on the hydrophilic coating.

A. Active Ingredients

Various active ingredients can be used in the present invention. In a preferred aspect, the active ingredient is a pesticide such as an insect growth regulator (IGR). Insect growth regulators (including juvenile hormones, JH) are well known for their use and efficacy in controlling or eliminating insect infestation in humans, in animals, and in both residential and industrial environments. Many types of insects are controllable by insect growth regulators, including flies (e.g., face flies, house flies, stable flies and horn flies), fleas, mosquitoes, flour beetles, cigarette beetles, and cockroaches. The insect growth regulators (IGRs) vary widely in chemical composition and two of the more prominent classes are 2,4-dienoic acids and phenoxyphenoxy compounds, particularly phenoxyphenoxyalkoxy heterocyclics, as well as benzoylureas and triazine derivatives. Preferably, dienoic acids, triazines, and benzoylureas are used.

Examples of 2,4-dienoic acids and related compounds are methoprene, hydroprene, neotenin, and epiphenonane. As used herein, “methoprene” includes R-methoprene, S-methoprene and mixtures of R and S methoprene. S-methoprene is the preferred methoprene.

Examples of phenoxyphenoxy compounds are fenoxycarb and pyriproxyfen.

Examples of benzoylureas are lufenuron, diflubenzuron, terflubenzuron, triflumaron, hexaflumaron, and flucycloxuron. An example of a triazine derivative is 2-cyclopropylamino-4,6-bis(dimethylamino)-s-triazine.

The following IGRs are suitable for the present invention. Chitin synthesis inhibitors are suitable such as bistrifluron, buprofezin, chlorfluazuron, cyromazine, diflubenzuron, flucycloxuron, flufenoxuron, hexaflumuron, lufenuron, novaluron, noviflumuron, penfluron, teflubenzuron, and triflumuron. In addition, juvenile hormone mimics are suitable such as epofenonane, fenoxycarb, hydroprene, kinoprene, methoprene, pyriproxyfen, and triprene. Further, juvenile hormones are suitable such as juvenile hormone I, juvenile hormone II, and juvenile hormone III. Other suitable IGRs include, molting hormone agonists, chromafenozide, halofenozide, and methoxyfenozide tebufenozide. Moreover, molting hormones such as α-ecdysone, and ecdysterone are suitable. In addition, molting inhibitors such as diofenolan and other IGRs, which include precocenes, such as precocene I, precocene II, and precocene III are suitable. Finally, unclassified insect growth regulators are suitable such as dicyclanil. Preferred IGRs include methoprene, hydroprene, kinoprene, fenoxycarb, pyriproxifen, and mixtures thereof. In the most preferred embodiment, methoprene is the IGR of choice.

In certain aspects, the amount of hydrophobic active ingredient is present in about 0.001% w/w to about 20% w/w, such as about 0.1% to about 10% such as 1% to about 8%, such as 1, 2, 3, 4, 5, 6, 7, or 8% w/w of active ingredient. In certain instances, the hydrophobic active ingredient is present in about 1% w/w to about 5% w/w such as 1-3% (1, 2, or 3%) and all fractions in between. The term “about” as used herein, includes a close, but imprecise quantity of a value. For example, in certain instances the term about includes 5%-10% higher, or 5-10% lower than the value given. For example, “about 10” includes the range of values from 9.5 to 10.5.

The active substance methoprene is sensitive to air oxidation, thermal breakdown and photo-catalytic degradation. Prior art formulations are hygroscopic and adsorb atmospheric moisture and are susceptible to agglomeration during production and can form hard blocks under hot and or humid conditions during storage. The present formulations solve these disadvantages and provides advantages the prior art does not possess.

B. Active Substance Stabilization on Granular Carriers

The hydrophobic active ingredient is preferably adsorbed, absorbed or a combination thereof on a solid granule carrier. The solid carrier is preferably corn cobb grit, dried molasses, soybean hulls, verxite, and mixtures thereof. In an especially preferred embodiment, the solid carrier is corn cobb grit.

Other solid carriers, which may be used for dusts, wettable powders, water dispersible granules, or granules, may be mineral fillers, such as calcite, silica, talc, kaolin, montmorillonite or attapulgite. The physical properties may be improved by addition of highly dispersed silica gel or polymers. Carriers for granules may be porous material, e.g. pumice, kaolin, sepiolite, bentonite; non-sorptive carriers include calcite or sand. Additionally, a multitude of pre-granulated inorganic or organic materials may be used, such as dolomite or crushed plant residues. Other suitable carriers include, but are not limited to, silica gel, sand, gypsum, charcoal, dry molasses and combinations thereof. In other instances, suitable materials include sand, vermiculite, diatomaceous earth, clay, or particulate cellulosic or organic type substances such as ground peanut hulls. Another source of core material is corn cobb particles known as Grit-0-Cobs available from The Andersons Corporation in Maumee, Ohio.

In certain aspects, the ratio of pesticide to solid carrier is about 0.001 to about 0.5 w/w %. Preferably, the ratio of pesticide to solid carrier is about 0.01 w/w to about 0.1 w/w such as 0.01, 0.02, 0.03, 0.04, 0.05, 0.06, 0.07, 0.08, 0.09 or 0.1 w/w %.

In certain aspects, the formulations of the present invention are solid formulations. Such solid formulations can be for example, a granule, a particle, a pellet, a capsule (e.g., a microcapsule), a tablet, a whole feed ration, and combinations thereof. In one embodiment, the solid formulation is about 50 μm to amount 5 mm in size. More preferably, the size is 0.2 mm to amount 2 mm in size such as about 0.3, 0.4, 0.5, 0.6, 0.7, 0.8, 0.9, 1.0, 1.1, 1.2, 1.3, 1.4, 1.5, 1.6, 1.7, 1.8, 1.9 and 2.0 mm. In one particular aspect, the solids are homogenous granules, filtered through wire mesh, such as 16 mesh or 40 mesh. The granules preferably have corn cobb grit as a solid carrier.

C. Hydrophilic/Hydrophobic Coatings

In certain aspects, the pesticide formulation of the present invention has a hydrophilic coating surrounding the granule or solid carrier after the hydrophobic active is absorbed onto the carrier. The amount of hydrophilic coating is about 1% to about 20% w/w, such as about 3% to about 15%, such about 5%-12% or about 7%-13%, or 1, 2, 3, 4, 5, 6, 7, 8, 9, 10, 11, 12, 13 14, 15, 16, 17, 18, 19, or 20% w/w, and all fractions in-between.

Hydrophilic coatings can be hydrophilic surfactants. Suitable hydrophilic substances include polyethylene glycol or sugar alcohols. Preferably the hydrophilic substance is PEG with a molecular weight of about PEG 300 to about PEG 10000, such as PEG 300, PEG 400, PEG 500, PEG 600, PEG 700, PEG 800, PEG 900, PEG 1000, PEG 2000, PEG 3000, PEG 4000, PEG 5000, PEG 6000, PEG 7000, PEG 8000, PEG 9000, PEG 10000, and combinations thereof.

Polysaccharides, disaccharides and monosaccharides can form sugar alcohols and are suitable for use in the present invention. In certain aspects, the sugar alcohol includes hexitols such as sorbitol, mannitol, galactitol, iditol, or inositol. In other instances, the sugar alcohols are reduced disaccharides. Hexitols are preferred sugar alcohols.

In still other aspects, after the hydrophilic coat is layered on, the inventive formulation comprises a hydrophobic or lipophilic substance. In certain aspects, the hydrophobic coat comprises a wax such as a paraffinic petroleum wax. In other instances, the hydrophobic substance comprises calcium stearate, magnesium stearate, stearic acid (having a maximum solubility in water of 3 mg/L), talc, or a mixture thereof. In certain other aspects, the hydrophobic solvent is a fat, vegetable oil, mineral oil or a combination thereof The fat or vegetable oil can be for example, a mono-glyceride, a di-glyceride, a tri-glyceride or a mixture thereof In certain aspects, the mineral oil is an aliphatic oil, a paraffinic oil, an isoparaffinic oil or a mixture thereof

The amount of hydrophobic coating is about 1% to about 20% w/w, such as about 3% to about 15%, such about 5%-12% or about 7%-13%, or about 1, 2, 3, 4, 5, 6, 7, 8, 9, 10, 11, 12, 13 14, 15, 16, 17, 18, 19, or 20% w/w, and fractions in-between.

Without being bound by any particular theory, it is believed that the hydrophobic active ingredient is immiscible with the hydrophilic coating, which coating prevents, inhibits, or retards migration of the active ingredient from the solid carrier. The addition of a hydrophobic or lipophilic coating material is added on the outside of the hydrophilic layer for protection against the oxidative nature of mineral feed. It is believed that the hydrophobic and hydrophilic coatings provide an adequate separation from the mineral feed and thus there exists a sufficient barrier to protect the active ingredient from the harsh chemical environment of mineral feed.

D. Method of Making

In one embodiment, an antioxidant is admixed to a hydrophobic active ingredient (e.g., methoprene) and then incorporated into an inert, lipophilic carrier with adequate mixing. Particles of the admixture are then infused into a solid carrier such as corn cobb grit. The particles are then coated with a hydrophilic coating material such as polyethylene glycol. After the particles are uniformly coated with the hydrophilic layer, a lipophilic coating optionally containing additional antioxidant is then applied. An antioxidant in the outer lipophilic layer (hydrophobic layer) has a benefit of having an antioxidant activity in place at a site separately from the site of the active substance.

E. Uses

In still other embodiments, the present invention provides a method for controlling or treating an insect on an animal such as cattle. The method includes administering a pesticide formulation as a feed-through product to the animal, wherein the pesticide formulation is formulated into a final form such as a granule, a particle, a pellet, a capsule such as a microcapsule, a cube, a tablet such as a microtablet, and combinations thereof. The feed-through product is allowed to pass through the animal into its manure. The pesticide formulation is released in the manure, thereby controlling the insect.

In one example, cattle are unacceptably infested with horn flies. Adult horn flies live 2 to 4 weeks taking 20 to 30 blood meals a day from the cattle. The pesticide formulation of the present invention is ingested with the cattle's mineral or feed. As they graze, cattle disperse the IGR via their manure. The composition of the present invention breaks the life cycle of the horn fly, by for example, preventing pupae from molting into adults. In 1 to 2 days, eggs hatch into larvae. After 3 to 5 days, the larvae molt into pupae. Preferably, the composition of the present invention, such as an IGR composition, prevents adult emergence following pupal stage.

The formulation is especially suitable for mineral feed. Such mineral feeds include, for example, mineral supplements used when there is a deficiency of certain chemical elements in livestock. In practice, feed rations are determined by the content of calcium, phosphorus, sodium, chlorine, and various trace elements in the feed. The majority of forage feeds are deficient in sodium and chlorine. Animals that feed primarily on forage feeds need a supplement of salt, which contains sodium and chlorine. Ground chalk, travertines, sapropel, limestones, wood ash, and gypsum are used as calcium supplements. When there is a deficiency in calcium and phosphorus, such phosphates as defluorinated phosphate, calcium phosphate, dicalcium phosphate, and disodium phosphate can be used.

In certain embodiments, the mineral feed that the present formulations can be added include calcium acetate, calcium carbonate, calcium chloride, calcium gluconate, calcium hydroxide, calcium iodate, calcium iodobehenate, calcium oxide, calcium sulfate (anhydrous or dihydrate), cobalt acetate, cobalt carbonate, cobalt chloride, cobalt oxide, cobalt sulfate, copper carbonate, copper chloride, copper gluconate, copper hydroxide, copper orthophosphate, copper oxide, copper pyrophosphate, copper sulfate, cuprous iodide, dicalcium phosphate, diiodosalicylic acid, disodium phosphate, ethylenediamine dihydroiodide, ferrous fumarate, iron ammonium citrate, iron carbonate, iron chloride, iron gluconate, iron oxide, iron phosphate, iron pyrophosphate, iron sulfate, reduced iron, magnesium acetate, magnesium carbonate, magnesium oxide, magnesium sulfate, manganese acetate, manganese carbonate, manganese chloride, manganese citrate (soluble), manganese gluconate, manganese orthophosphate, manganese oxide, manganese phosphate (dibasic), manganese sulfate, monocalcium phosphate, monosodium phosphate, potassium acetate, potassium bicarbonate, potassium carbonate, potassium chloride, potassium iodate, potassium iodide, potassium sulfate, sodium acetate, sodium chloride, sodium bicarbonate, sodium iodate, sodium iodide, sodium sulfate, sodium tripolyphosphate, sulfur, thymol iodide, tricalcium phosphate, zinc acetate, zinc carbonate, zinc chloride, zinc oxide, and zinc sulfate.

In certain embodiments, the present invention provides a mineral feed composition comprising a pesticide formulation, the formulation comprising:
a) a hydrophobic active ingredient on a solid carrier;
b) a hydrophilic coating contacting the solid carrier;
c) an antioxidant; and
d) an optional external hydrophobic coating contacting the hydrophilic coating, admixed into a mineral feed.

The formulations of the present invention can be admixed with mineral feed to make a mineral feed composition of the present invention. The formulation can be mixed or blended into medicated feeds, mineral feeds, and the like. The end use product can have a concentration of about 0.0001% to about 20% w/w active ingredient (e.g., IGR), such as methoprene. For example, the mineral feed can have about 0.0001% to about 20% w/w methoprene such as 0.0025% to about 10.5%, such as about 0.005% to about 1% w/w, such as 0.01% to about 0.5% w/w, or about 0.01% to about 0.4% w/w. In certain instances, the use level is about 0.1 mg/cwt/day to about 3.0 mg/cwt/day such as about 1.13 mg/cwt/day. The formulation can be a feed concentrate to mix with free-choice-fed minerals or mixed-ration feeds.

### II. Examples

### Example 1

### Stability Study with a Methoprene Formulation in Mineral Feed

### Formulations

TABLE 1

| | | (w/w)% of S-Methoprene in the | | | | | | |
|---|---|---|---|---|---|---|---|---|
| | | CP-2 Spiked in the Minerals | | | | % Recovery (% of Initial) | | |
| | | | 1 | 2 | 3 | 1 | 2 | 3 |
| Sample # | Formula | Initial | month | months | months | month | months | months |
| Comparative | CP-2 | 2.05 ± 0.03 | 1.70 ± 0.04 | 1.64 ± 0.04 | 1.66 ± 0.05 | 82.93 ± 1.95 | 80.00 ± 1.95 | 80.98 ± 2.44 |
| | 100405 | | | | | | | |
| JP1002-1 | MP1014 + | 2.53 ± 0.07 | 2.32 ± 0.07 | 2.25 ± 0.08 | 2.13 ± 0.16 | 91.70 ± 2.77 | 88.93 ± 3.16 | 84.19 ± 6.32 |
| | Methoprene | | | | | | | |
| | Ethox/OA | | | | | | | |
| | w/o coating | | | | | | | |
| JP1002-1-2 | MP1014 + | 2.14 ± 0.02 | 1.99 ± 0.01 | 1.93 ± 0.10 | 1.83 ± 0.06 | 92.99 ± 0.47 | 90.19 ± 4.67 | 85.51 ± 2.80 |
| | Methoprene | | | | | | | |
| | Ethox/OA | | | | | | | |
| | 14% PEG 8000 | | | | | | | |
| JP1002-1-3 | MP1014 + | 2.21 ± 0.04 | 2.11 ± 0.02 | 2.06 ± 0.05 | 2.02 ± 0.07 | 95.48 ± 0.90 | 93.21 ± 2.26 | 91.40 ± 3.17 |
| | Methoprene | | | | | | | |
| | Ethox/OA | | | | | | | |
| | 11% PEG 8000 | | | | | | | |
| JP1002-2-4 | MP1014 + | 2.26 ± 0.04 | 2.15 ± 0.03 | 2.11 ± 0.04 | 2.01 ± 0.08 | 95.13 ± 1.33 | 93.36 ± 1.77 | 88.94 ± 3.54 |
| | Methoprene | | | | | | | |
| | Ethox/OA/Sorbitol | | | | | | | |
| | 11% PEG 8000 | | | | | | | |

Comparative represents a formulation disclosed in U.S. Pat. No. 7,163,687.
JP1002-1-3: formulation using the corn grit carrier, ethoxyquin, oleic acid and 11% PEG coating.

TABLE 2

| | | (w/w)% of S-Methoprene in the | | | % Recovery | |
|---|---|---|---|---|---|---|
| | | CP-2 Spiked in the Minerals | | | (% of Initial) | |
| Sample # | Formula | Initial | 3 months | 6 months | 3 months | 6 months |
| Comparative | CP-2 | 2.05 ± 0.03 | 1.65 ± 0.04 | 1.53 ± 0.06 | 80.49 ± 1.95 | 74.63 ± 2.93 |
| | 100405 | | | | | |
| JP1002-1 | MP1014 + Methoprene | 2.53 ± 0.07 | 2.27 ± 0.04 | 2.05 ± 0.04 | 89.72 ± 1.58 | 81.03 ± 1.58 |
| | Ethox/OA | | | | | |
| JP1002-1-2 | MP1014 + Methoprene | 2.14 ± 0.02 | 2.01 ± 0.01 | 1.78 ± 0.04 | 93.93 ± 0.47 | 83.18 ± 1.87 |
| | Ethox/OA | | | | | |
| | 14% PEG 8000 | | | | | |
| JP1002-1-3 | MP1014 + Methoprene | 2.21 ± 0.04 | 2.06 ± 0.05 | 1.85 ± 0.07 | 93.21 ± 2.26 | 83.71 ± 3.17 |
| | Ethox/OA | | | | | |
| | 11% PEG 8000 | | | | | |
| JP1002-2-4 | MP1014 + Methoprene | 2.26 ± 0.04 | 2.10 ± 0.03 | 1.88 ± 0.03 | 92.92 ± 1.33 | 83.19 ± 1.33 |
| | Ethox/OA/Sorbitol | | | | | |
| | 11% PEG 8000 | | | | | |

### Results

The testing results indicate that the coated granules have superior stability, while maintaining physical consistency and flow-ability in typical conditions. The formulations succeed in meeting all of desired characteristics for improved stability when mixed with commercial mineral mixtures as well as superior shelf-life stability in packaging.

Stability screens show that the inventive coated granules with a prior art granule. The results indicate that the inventive formulation is superior. Each data point was taken in triplicate with standard deviations reported in the data tables.

### Example 2

### Production Feasibility Run and Stability

An objective of the current formulation is to provide stability to maintain levels greater than 80% of the confidential statement of formula (CSF) active ingredient limits at 24 months in packaging.

A further objective is to provide a formulation having stability to maintain levels greater than 90% of the CSF active ingredient limit at 6 months and 80% at 12 months in a commercial mineral feed.

### Formulation A (Used in a Several Ton Continuous Run)

| Component | % w/w |
|---|---|
| PEG 8000 | 10% |
| methoprene | 2.2% |
| ethoxyquin | 1.5% |
| oleic acid | 4.0% |

### Formulation B

| Component | % w/w |
|---|---|
| Sorbitol | 10% |
| | (1^{st} coat) |
| PEG 8000 | 10% |
| | (2^{nd} coat) |
| methoprene | 2.2% |
| ethoxyquin | 1.5% |
| oleic acid | 4.0% |

Table 3 shows the percent recovery of S-methoprene from the inventive formulation. The formulation is spiked in commercial mineral feed at room temperature. The w/w % is based on initial w/w %.

TABLE 3

| | | (w/w)% of S-Methoprene in the | | | % Recovery | |
|---|---|---|---|---|---|---|
| | | CP-2 Spiked in the Minerals | | | (% of Initial) | |
| | | | 40° C. 3 | RT 6 | 40° C. 3 | RT 6 |
| Sample # | Formula | Initial | months | months | months | months |
| Control | Molasses CP-2 | 2.14 ± 0.05 | 1.70 ± 0.04 | 1.78 ± 0.05 | 79.44 ± 1.87 | 83.18 ± 2.34 |
| | Lot: 1102086724 | | | | | |
| GG511-123A | MP1014 + Methoprene | 2.12 ± 0.04 | 2.01 ± 0.04 | 2.00 ± 0.04 | 94.81 ± 1.89 | 94.34 ± 1.89 |
| | Sorbitol + PEG | | | | | |
| | Run # 5 (30) | | | | | |
| GG511-123B | MP1014 + Methoprene | 2.21 ± 0.04 | 1.94 ± 0.04 | 1.95 ± 0.03 | 87.78 ± 1.81 | 88.24 ± 1.36 |
| | 10% PEG 8000 | | | | | |
| | Run # 4 (27) | | | | | |
| GG511-123C | MP1014 + Methoprene | 2.35 ± 0.03 | 2.16 ± 0.04 | 2.19 ± 0.06 | 91.91 ± 1.70 | 93.19 ± 2.55 |
| | 10% Sorbitol | | | | | |
| | Run # 1 (1) | | | | | |

Table 4 shows the percent recovery of S-methoprene from the inventive formulation. The formulation is spiked in commercial mineral feed at room temperature. The w/w % is based on initial w/w %.

TABLE 4

| | | (w/w)% of S-Methoprene in the | | | % Recovery | |
|---|---|---|---|---|---|---|
| | | CP-2 Spiked in the Minerals | | | (% of Initial) | |
| Sample # | Formula | Initial | 3 months | 6 months | 3 months | 6 months |
| Control | Molasses CP-2 | 2.19 ± 0.11 | 1.98 ± 0.06 | | 90.41 ± 2.74 | |
| | Lot: 1102086724 | | | | | |
| GG511-123A | MP1014 + Methoprene | 2.10 ± 0.04 | 2.01 ± 0.03 | | 95.71 ± 1.43 | |
| | Sorbitol + PEG | | | | | |
| | Run # 5 (30) | | | | | |
| GG511-123B | MP1014 + Methoprene | 2.11 ± 0.02 | 1.95 ± 0.03 | | 92.42 ± 1.42 | |
| | 10% PEG 8000 | | | | | |
| | Run # 4 (27) | | | | | |
| GG511-123C | MP1014 + Methoprene | 2.33 ± 0.04 | 2.20 ± 0.03 | | 94.42 ± 1.29 | |
| | 10% Sorbitol | | | | | |
| | Run # 1 (1) | | | | | |
| GG511-123B1 | MP1014 + Methoprene | 2.18 ± 0.02 | 2.07 ± 0.03 | | 94.95 ± 1.38 | |
| | 10% PEG 8000 | | | | | |
| | Run # 3 (4) | | | | | |
| GG511-123-2 | MP1014 + Methoprene | 2.31 ± 0.01 | 2.15 ± 0.06 | | 93.07 ± 2.60 | |
| | Uncoated | | | | | |
| | Run # 2 (2) | | | | | |

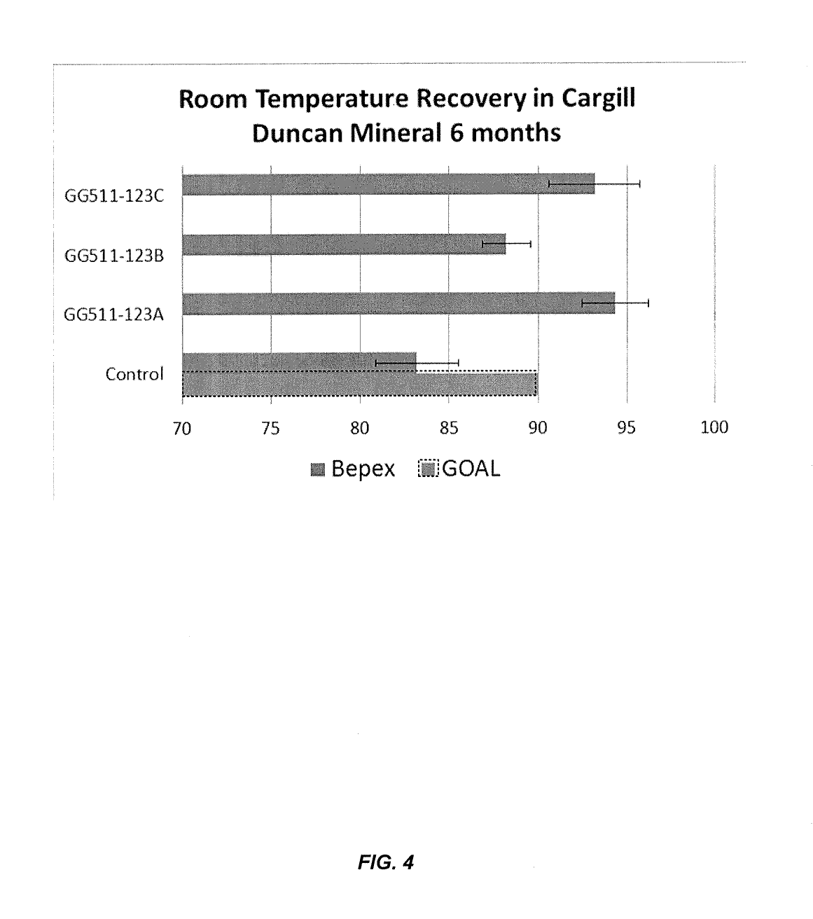

As is shown in FIG. 4, the inventive formulations of 123A-C manufactured using

Bepex equipment, exceeded the control and the Goal (bottom trace). The inventive formulations maintain greater than 90% of the initial active ingredient at 6 months.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

1. A pesticide formulation, the formulation comprising:
a) a hydrophobic active ingredient on a solid carrier;
b) a hydrophilic coating contacting the solid carrier;
c) an antioxidant; and
an optional external hydrophobic coating contacting the hydrophilic coating.

2. The pesticide formulation according to claim 1, wherein the active ingredient is an insect growth regulator (IGR).

3. The pesticide formulation according to claim 2, wherein the IGR is a member selected from the group consisting of methoprene, diflubenzuron, pyriproxyfen and a combination thereof.

4. The pesticide formulation according to claim 3, wherein the IGR is methoprene.

5. The pesticide formulation according to claim 1, wherein the solid carrier is selected from the group consisting of corn cobb grit, dried molasses, soybean hulls, verxite, and mixtures thereof.

6. The pesticide formulation according to claim 1, wherein the solid carrier is corn cobb grit.

7. The pesticide formulation according to claim 1, wherein the antioxidant is selected from the group consisting of vitamin E, vitamin E acetate, vitamin A palmitate, propyl gallate, butylated hydroxyanisole (BHA), butylated hydroxytoluene (BHT), ethoxyquin, oleic acid, and combinations thereof.

8. The pesticide formulation according to claim 7, wherein the antioxidant is ethoxyquin, or oleic acid.

9. The pesticide formulation according to claim 1, wherein the hydrophilic coating is selected from the group consisting of a polyethylene glycol from about PEG 300 to about PEG 10000 or sorbitol.

10. The pesticide formulation according to claim 9, wherein the hydrophilic layer comprises PEG 8000.

11. The pesticide formulation according to claim 1, wherein the hydrophobic coating is a member selected from the group consisting of paraffinic petroleum wax, calcium stearate, magnesium stearate, stearic acid, talc, and mixtures thereof.

12. The pesticide formulation according to claim 1, wherein the antioxidant is associated with the solid carrier.

13. The pesticide formulation according to claim 1, further comprising said external hydrophobic coating.

14. The pesticide formulation according to claim 13, wherein the antioxidant is associated with the hydrophobic active ingredient on the solid carrier.

15. The pesticide formulation according to claim 13, wherein the antioxidant is associated with the solid carrier and the hydrophobic coating.

16. The pesticide formulation according to claim 1, wherein the formulation contains from about 0.5% to about 10% w/w of the methoprene active ingredient.

17. The pesticide formulation according to claim 16, wherein the formulation contains about 2% w/w of the methoprene active ingredient.

18. The pesticide formulation according to claim 1, wherein the formulation is formulated into a final form selected from the group consisting of a granule, a particle, a pellet, a capsule, a tablet, and combinations thereof.

19. The pesticide formulation according to claim 1, wherein the formulation is formulated into a final form selected from the group consisting of a block, a cube, a poured block, and a tub.

20. A method for controlling an insect on cattle, the method comprising: oral administration of a pesticide formulation to cattle, the formulation comprising
a) methoprene on a solid carrier;
b) a hydrophilic coating contacting the solid carrier;
an antioxidant;
c) an optional external hydrophobic coating contacting the hydrophilic coating; and
allowing the formulation to pass through the cattle into manure, wherein the pesticide is released into the manure thereby controlling the insect.

21-33. (canceled)
